(19) United States
(12) Patent Application Publication
(10) Pub. No.: US 2026/0323175 A1
(43) Pub. Date: Oct. 15, 2026

(54) SYSTEMS AND METHODS OF HIGH-DYNAMIC RANGE (HDR) IMAGING AND SENSING USING A MULTIFUNCTIONAL METASURFACE

(71) Applicant: Purdue Research Foundation, West Lafayette, IN (US)

(72) Inventors: Qi Guo, West Lafayette, IN (US); Yuxuan Liu, West Lafayette, IN (US); Charles Brookshire, Hamilton, OH (US); Yuanrui Chen, West Lafayette, IN (US)

(21) Appl. No.: 19/301,604

(22) Filed: Aug. 15, 2025

Related U.S. Application Data
(60) Provisional application No. 63/684,536, filed on Aug. 19, 2024.
(60) Provisional application No. 63/764,542, filed on Feb. 27, 2025.

(51) Int. Cl. H04N 25/57; B82Y 20/00; G06T 5/92; H04N 23/55; H04N 23/84

(52) U.S. Cl. CPC H04N 25/57; B82Y 20/00; G06T 5/92; H04N 23/55; H04N 23/84; G06T 2207/20221

(57) ABSTRACT

Systems and methods capable of capturing high dynamic range (HDR) images with relative few exposures, for example, a single exposure. A high-dynamic range imaging and sensing system includes a photosensor and a multifunctional metasurface utilizing random interleaving to unevenly divide incident light into focused beams of different powers and deflect the focused beams onto different locations on the photosensor to form multiple low dynamic range images. Methods of operating such high-dynamic range imaging and sensing system include jointly processing the multiple low dynamic range images using a gradient-based high-dynamic range fusion algorithm to reconstruct a high-dynamic range image, and/or performing high-dynamic range imaging and sensing in a single-shot exposure to construct a high-dynamic range image.

### CROSS-REFERENCE TO RELATED APPLICATIONS

This application claims the benefit of provisional U.S. Patent Application No. 63/684,536 filed Aug. 19, 2024, and of provisional U.S. Patent Application No. 63/764,542 filed Feb. 27, 2025, the contents of each of which are incorporated herein by reference.

STATEMENT REGARDING PRIOR DISCLOSURES BY THE INVENTOR OR A JOINT INVENTOR

Portions of the present disclosure were disclosed previously by one or more of the joint inventors of the present invention in an article entitled “MetaHDR: single shot high-dynamic range imaging and sensing using a multifunctional metasurface,” by Charles Brookshire, et al., published online on Apr. 30, 2024, available online at https://preprints.opticaopen.org/articles/preprint/MetaHDR_Single_Shot_High-Dynamic_Range_Imaging_and_Sensing_using_a_Multifunctional_Metasurface/25719513/1, and again on Jul. 9, 2024, available at https://doi.org/10.1364/OE.528270. The contents of each of these publications are incorporated herein by reference

### BACKGROUND OF THE INVENTION

The present invention generally relates to imaging systems and methods. The invention particularly relates to systems and methods capable of capturing high dynamic range (HDR) images with relative few exposures, preferably a single exposure.

HDR (High Dynamic Range) imaging in photography refers to a technique that captures a wider range of luminosity (from the darkest shadows to the brightest highlights) in an image of a scene than standard photography can typically record. In this context, the term dynamic range refers to the difference between the darkest and brightest parts of an image.

HDR imaging and sensing have broad applications. From scientific discoveries to national defense, cameras and visual sensors are needed that are capable of measuring the full visual appearance of objects of interest. Nowadays, the most widely used photosensors capture RAW images (i.e., digital image files that contain unprocessed or minimally processed data from the image sensor) with a bit depth between 12-16 bits. While this allows images to ideally capture scenes with dynamic ranges from approximately 1:4,000 to 1:60,000, the dynamic range of a natural scene may be as much as approximately 1:3,000,000. As evident from FIG. 1, the result can be the inability to capture the full visual appearance of objects where intense brightness variation exists. Therefore, approaches to increase the dynamic range of cameras are critical and very useful.

One of the most straightforward approaches to achieve HDR imaging without increasing hardware complexity is exposure bracketing, represented in FIG. 2. This class of methods requires capturing a series of images with a fixed interval of exposure times and then fusing these images together. However, such a multi-frame exposure bracketing approach is premised on both the camera and the scene being static throughout the image capture period. When there is a relative movement between the camera and the scene during the capture period, however, sophisticated algorithms are required to align and fuse the images together.

In view of the above, it would be desirable if systems and methods were available that were capable of capturing HDR images with fewer exposures, optimally a single exposure.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, systems and methods capable of capturing high dynamic range (HDR) images with relatively few exposures, for example, with a single exposure.

According to a nonlimiting aspect of the invention, a high-dynamic range imaging and sensing system includes a photosensor and a multifunctional metasurface having random interleaved nanocells that unevenly divide incident light into focused beams of different powers and deflect the focused beams onto different locations on the photosensor to form multiple low dynamic range images.

According to another nonlimiting aspect of the invention, high-dynamic range cameras are provided that include a high-dynamic range imaging and sensing system as described above and a diaphragm configured to direct the incident light onto the multifunctional metasurface.

According to another nonlimiting aspect of the invention, methods of operating the high-dynamic range imaging and sensing system are provided. Such a method includes performing high-dynamic range imaging and sensing in a single-shot exposure to construct a high-dynamic range image. As a nonlimiting example, the method may include jointly processing the multiple low dynamic range images using a gradient-based high-dynamic range fusion algorithm to reconstruct a high-dynamic range image. In some embodiments, the methods may additionally or alternatively include jointly performing high dynamic range imaging and hyperspectral imaging in a single snapshot. The multiple low dynamic range images may include more than four low dynamic range images, for example, nine or more low dynamic range images.

Technical aspects of systems and methods as described above preferably include the ability to capture HDR images with a minimal number of exposures, and more preferably a single exposure.

Other aspects and advantages will be appreciated from the following detailed description as well as any drawings.

### BRIEF DESCRIPTION OF THE DRAWINGS

FIG. 1 represents a prior art example of an attempt to use a conventional camera to capture the full visual appearance of objects in a natural scene in which intense brightness variation exists.

FIG. 2 represents a prior art example of exposure bracketing.

FIG. 3 represents an example high-dynamic range imaging and sensing system (“MetaHDR”) system according to certain nonlimiting aspects of the invention.

FIG. 4A schematically represents a metasurface and an imaging photosensor of a MetaHDR system according to certain nonlimiting aspects of the invention. FIG. 4B shows an individual nanocell of the metasurface according to certain nonlimiting aspects of the invention.

FIGS. 5A-5C represent certain details of an experimental metasurface such as represented in FIG. 3 and used in investigations leading to the present invention. FIG. 5A represents a phase delay and transmittance look-up table (LUT) for nanocells of the metasurface having an operating wavelength 650 nm. Each nanocell had a base with dimensions of about 300 nm×300 nm and an α-silicon (α-Si) cylinder forming a nanopillar centered on the base. The nanopillar can be parameterized using the radius r of the cylinder. The nanocells in the LUT cover a 21 range of phase delay and achieve a minimum of 0.8 transmittance for the operating wavelength 650 nm. FIG. 5B represents the phase delay profile of the metasurface. The experimental metasurface is 1 mm in diameter, with 3335 nanocells in each dimension. The inset images of FIG. show close-up views of the phase delay profiles and random interleaving indices. FIG. 5C depicts parallel and oblique SEM images of metasurface nano-structures. Scale bars are 1 μm.

FIG. 6A schematically represents a camera incorporating an experimental MetaHDR according to a nonlimiting example of the invention. FIG. 6B represents nine images of varying luminosity power captured simultaneously in a single shot with the camera of FIG. 6A.

FIGS. 7A and 7B represent geometric alignment and contrast alignment of the experimental MetaHDR. FIG. 7A depicts a sample full image of the calibration target with sub-image division. FIG. 7B depicts key point detection between I₂ and I₃ for geometric alignment. FIG. 7C represents a cross-section of the sample sub-image spatial gradient after calibration. After dividing the corresponding power ratios, the intensity profiles of the spatial gradient closely match each other.

FIG. 8 contains a table of the calibrated power ratio of each sub-image of the MetaHDR. The power ratio reported in FIG. 8 is the intensity ratio of the sub-image over the ideal image. The power ratios between most adjacent sub-images, αᵢ and αᵢ₊₁, have a proportion of around 2, which is consistent with the design of the MetaHDR. The total power ratio among the nine images, α₁/α₉, is 562.5. Therefore, the experimental MetaHDR can maximally increase the dynamic range by a ratio of 562.5, or 55.00 dB, via exposure bracketing.

FIG. 9 depicts single-shot HDR imaging results of five different scenes captured using the experimental MetaHDR.

FIGS. 10A and 10B represent artifact attenuation via two different HDR fusion methods for purposes of comparison. FIG. 10A depicts intensity-based HDR fusion with tonemapping. FIG. 10B depicts gradient-based HDR fusion with tonemapping according to some nonlimiting aspects of the present invention.

FIG. 11 contains a table comparing the experimental MetaHDR and a hypothesized 9-exposure mosaicking HDR imager. The light efficiencies of both methods are estimated and the HDR image quality generated using the corresponding light efficiencies is analyzed for both methods. The results show clear differences in HDR reconstruction quality on all three metrics caused by differences in the light efficiency of both solutions.

FIG. 12 schematically represents a metasurface camera system according to still further nonlimiting aspects of the invention.

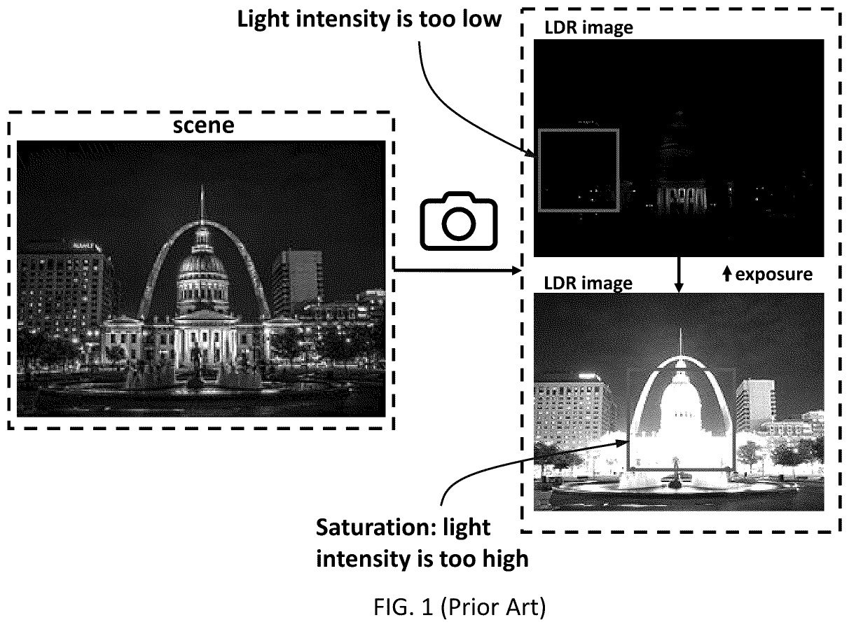

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) depicted in the drawings. The following detailed description also describes certain investigations relating to the embodiment(s) and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects described as part of different embodiments. Therefore, the appended claims, and not the detailed description, are intended to particularly point out subject matter regarded to be aspects of the invention, including certain but not necessarily all of the aspects and alternatives described in the detailed description.

The following disclosure describes systems for generating single-capture HDR images, referred to herein as a MetaHDR system or MetaHDR as a matter of convenience, as well as investigations of the MetaHDR system evidencing various aspects of the invention. The MetaHDR system is capable of operating as a single-shot high-dynamic range (HDR) imaging and sensing system using a multifunctional metasurface lens (hereinafter, metasurface) and a photosensor. A metasurface is a planar glass substrate patterned with nanoscale structures to manipulate the traversing light. Metasurfaces can provide advantages in computational imaging due to their compactness and multifunctionality in imaging systems. As disclosed herein, the metasurface is capable of splitting an incident beam into multiple focusing beams with different amounts of power, and simultaneously deflecting the multiple focusing beams toward a photosensor to form multiple low dynamic range (LDR) images with distinct irradiance on the photosensor. Then, the LDR images can be jointly processed using a gradient-based HDR fusion algorithm, which was shown in investigations leading to the invention to be effective in attenuating the residual light artifacts incurred by the metasurface and the lens flare. The investigations of the MetaHDR achieved single-shot HDR photography (still images) and videography (video images) that increased the dynamic range by at least 50 dB compared to the original dynamic range of the photosensor. The MetaHDR can also perform single-shot HDR sensing, including reflectance calibration and surface curvature estimation of reflective materials. The MetaHDR's demonstrated functionalities could be broadly applied in surveillance and security, microscopic imaging, and advanced manufacturing, as well as other applications.

Solutions are known for generating single-capture HDR images, including both hardware-driven solutions and software-driven solutions. Previous hardware-driven systems for generating single-capture HDR images have involved exposure mosaicking, such as manipulating the transmittance, polarization, or exposure time of groups of pixels, rows of pixels, or individual pixels, to obtain an image encoding multiple exposure times worth of information. These methods reduce the number of captures to generate an HDR image, as they use uniquely capable photosensors, instead of optics, to achieve fine-tuned pixel control. However, the maximum number of single-shot exposure bracketing successfully demonstrated with exposure mosaicking has been limited and constrains the highest achievable dynamic range of the system. In contrast, investigations leading to the present invention demonstrated the simultaneous capture of as many as nine exposure-bracketed images, which increased the dynamic range by at least 10 dB compared to previous exposure mosaicking solutions.

Previous hardware-driven systems for generating single-capture HDR images have also utilized photon-counting imaging photosensors and neuromorphic cameras. Quanta imaging sensors (QIS) and single-photon avalanche diode (SPAD) based imaging photosensors are both capable of high-speed photon counting with a low readout noise. Utilizing these properties, multiple exposure images can be generated within a single exposure time (single-shot) and HDR images can be generated using exposure bracketing reconstruction, referred to herein as single-shot exposure bracketing. Neuromorphic cameras, such as event cameras, are high frame rate cameras that measure intensity change. While it has been shown that asynchronous event detection can be utilized to increase the dynamic range of photosensor hardware, they tend to be used as a supplementary device in neural network-based solutions for HDR reconstruction, or as direct network inputs. These HDR solutions require specialized photosensors and circuitry rather than more conventional camera technology, for example, CMOS cameras. In contrast, investigations leading to the present invention demonstrated the suitability of widely-used camera and sensor technologies, such as CMOS cameras, for use in the MetaHIDR system.

This disclosure also describes some nonlimiting embodiments of a metasurface camera system that can jointly perform high dynamic range (HDR) and hyperspectral imaging in a single snapshot. The metasurface camera may integrate exposure bracketing and computed tomography imaging spectrometry (CTIS) by simultaneously forming multiple spatially multiplexed projections with unique power ratios and chromatic aberrations on a photosensor. The measurements subsequently may be processed through a deep reconstruction model to generate an HDR image and a hyperspectral datacube. Simulation studies show that the metasurface camera system can, in some configurations, achieve higher reconstruction accuracy than previous snapshot hyperspectral imaging methods on benchmark datasets. A nonlimiting example working prototype demonstrated snapshot reconstruction of 60 dB dynamic range and 10 nm spectral resolution from 600 nm to 700 nm on real-world scenes from a monochrome photosensor.

The high-dynamic range imaging and sensing system (“MetaHDR”) system disclosed herein is capable of addressing issues associated with pre-existing multi-frame exposure bracketing methods by utilizing a metasurface to achieve exposure bracketing in a single shot for HDR imaging and sensing.

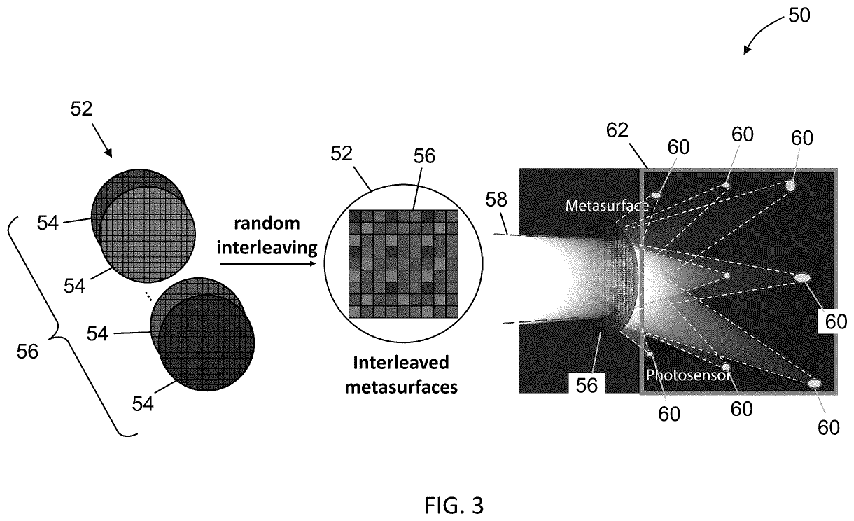

FIG. 3 schematically represents a high-dynamic range imaging and sensing (“MetaHDR”) system 50 includes a lens 52 with a plurality of interleaved metasurfaces 54 (together, called a “multifunctional metasurface” 56) adapted to split (divide), deflect, and focus incident light 58 at multiple focal positions 60 on a photosensor 62. Each focal position 60 has a different power. The multifunctional metasurface 56 was designed and fabricated to be capable of splitting (dividing), deflecting, and focusing the incident light 58 to form multiple focused beams that are directed at multiple evenly spaced positions on the photosensor 62. Each focused beam contains a select ratio of power incident on the multifunctional metasurface 56. This configuration mimics exposure bracketing captures by obtaining multiple different images at multiple different luminosity powers. In this way, the MetaHIDR system 50 configured with the multifunctional metasurface 56 is able to capture multiple images simultaneously in a single shot, with every photodetector having the same integration time. This disclosure describes the design and demonstration of an experimental metasurface 54 that was shown to serve as a multi-beamsplitter with a specific energy distribution and a focusing lens. Multifunctionality is an important use of metasurfaces in computational imaging. There have been multifunctional metasurfaces that exert different modulation functions to the incident wave according to spatial location, polarization, wavelength, incident angle, etc. The investigations leading to the present invention, however, demonstrated a nonlimiting example multifunctional metasurface 56 having a random interleaving configuration of the individual metasurfaces 54 that simultaneously formed nine images. The nine simultaneously formed images were formed with preselected, designed power ratios. Other configurations could implement more or fewer metasurfaces 54, different power ratios, and/or form more or fewer images.

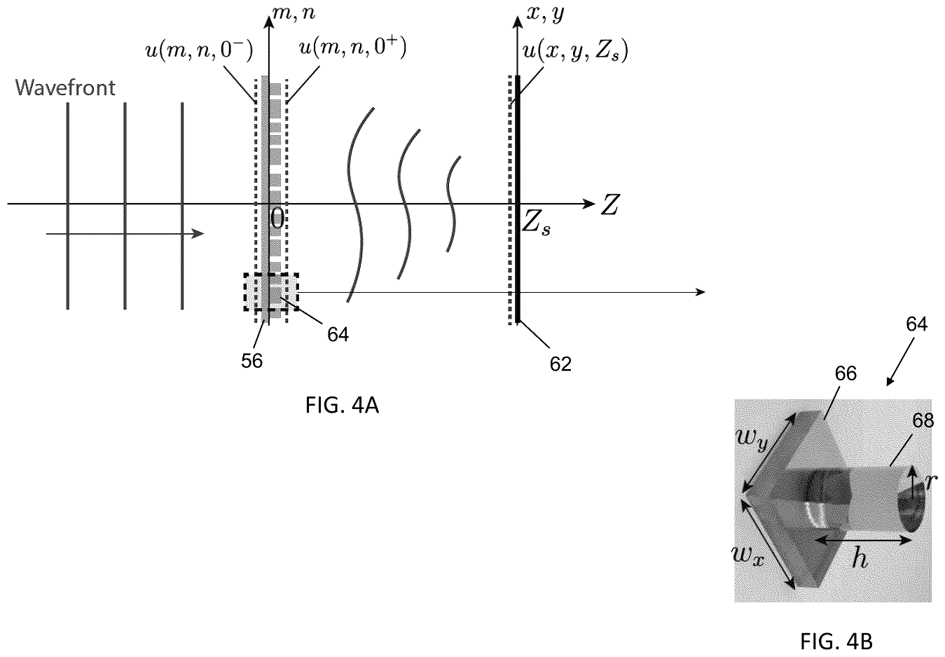

FIG. 4A illustrates an image light wavefront propagating towards the photosensor 62 along the Z-axis. The wavefront interacts with the metasurface 56 which includes a plurality of nanocells 66. The nanocells 66 are typically arranged in an array, such as a rectangular array, but may be arranged in other types of arrays. The metasurface 56 performs a complex modulation to the traversing wavefront, as characterized by the shape of each nanocell at position (m,n) in the array. The modulated wavefront then propagates a distance Zs to be measured as an image by the photosensor 62.

As best seen in FIG. 4B, an individual nanocell 64 of the metasurface 56 has a generally rectangular base 66 with a fixed cell size (wₓ, w_{y}) and a nano-cylinder 68 projecting out from one side of the base a nano-cylinder height, h. The phase and transmittance applied by the nanocell 64 to light waves propagated therethrough are determined by the radius r of the nano-cylinder 68 and/or other dimensions and/or properties of the nanocell. The nanocells 64 may be made of any suitable material, such as fused silica glass, α-silicon film, and/or other suitable materials.

The investigations also utilized a gradient-based HDR reconstruction algorithm that paired with the optical design of the multifunctional metasurface 56. This algorithm enables the observation of inevitable artifacts in the raw measurement, which can corrupt the HDR image generated using traditional HDR reconstruction algorithms. Such artifacts may include, for example, residual lighting caused by metasurface fabrication defects, lens flares on dim images, and/or blending of bright images to dim images. The investigations showed that the gradient-based reconstruction algorithm disclosed herein can effectively attenuate these artifacts in the output HDR images obtained with the MetaHDR system 50.

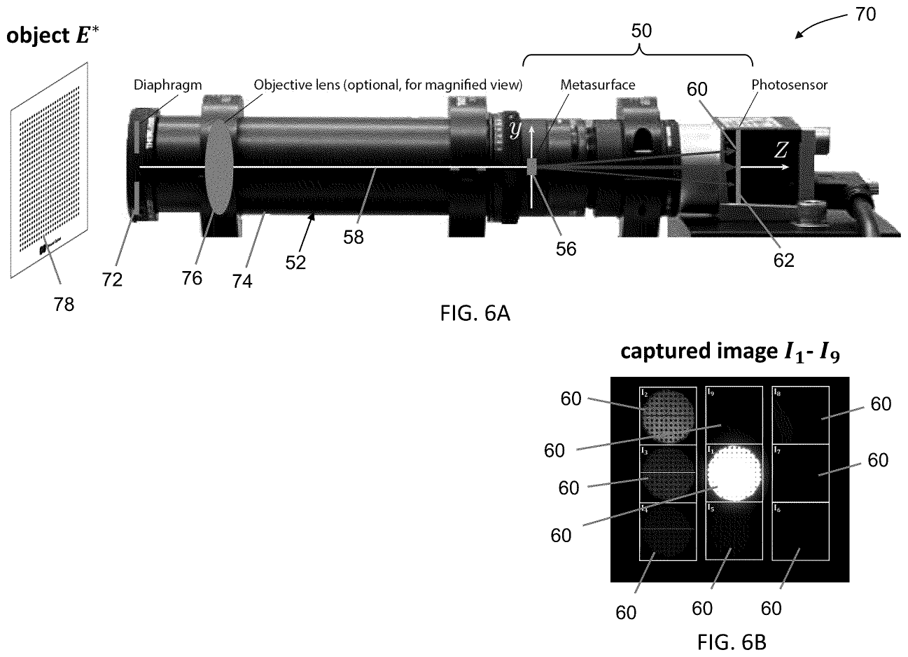

As shown in FIG. 6A, for the investigations, an experimental MetaHIDR system 50 was assembled to be capable of operating as a single-shot HDR camera 70. In this nonlimiting example configuration, the metasurface 56 is mounted 5 cm from the image photosensor 62. A diaphragm 72 with an additional lens tubing 76 constrains the field of view so that the nine sub-images 60 shown in FIG. 6B have minimal overlap. The experimental MetaHDR system 50 can optionally insert a second objective lens 76 to provide a magnified view and/or improved light efficiency. The photosensor 62 used was a Basler ace acA2440-35 μm monochrome digital camera with 5M pixels, although other types of digital photo sensors could be used. The experimental MetaHDR system 50 operated in a 10 nm bandwidth of working wavelength (645 nm-655 nm) and captured HDR still images and HDR real-time videos at 500×500-pixel resolution with 50 dB higher dynamic range in addition to the original dynamic range of the photosensor, which is at least 10 dB higher than previous single-shot HDR solutions. It is understood that other configurations could be implemented for the HDR camera 70. In addition, the investigations demonstrated the successful use of the MetaHDR 50 to achieve single-shot visual sensing, including surface reflectance calibration and surface curvature estimation of reflective materials from the specularities. Specularities of reflective materials are traditionally treated as unuseful information in computer vision due to the high dynamic range required to capture this information. The MetaHDR 50 was shown to measure the full intensity profile of a specularity and turn it into useful visual information for material and shape estimation thanks to its extremely high dynamic range, which demonstrated a new potential path for shape reconstruction of reflective materials.

Nonlimiting aspects and embodiments of the invention will now be described below in reference to the experimental investigations leading up to the invention.

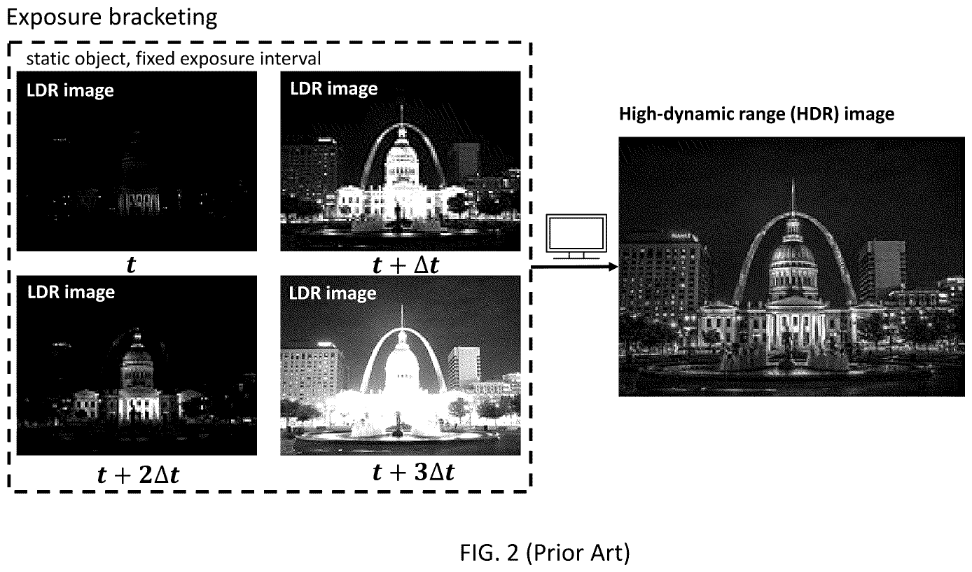

Metasurface Design and Image Formation Model: The experimental MetaHDR utilized a multifunctional metasurface 56 that served as a multi-beam splitter and a focusing lens, as schematically represented in FIG. 2. The following describes certain aspects of the design process of the metasurface 56. The investigations modeled a metasurface, M, as a two-dimensional array of uniform-shape nanocells 64 on a uniform grid G: M={C(m, n)|m, n∈G}, where each nanocell (m, n) is represented by the modulation function C(m, n) it exerts to the traversed wavefront. Specifically, the modulation function C(m, n) exerts a transmittance T(m, n) and phase delay φ(m, n): C(m, n)=T(m, n)e^{jφ(m,n)}, which is determined by the nano-structure of each nanocell. For the investigations, centered nano-cylinders at a fixed height were used (FIG. 4B) that enabled a nanocell's modulation function C(m,n) to be represented as a mapping from the nano-cylinder radius r of the nanocell: C(m, n)=ƒ(r(m, n)). The function ƒ( ) was emulated with a look-up table (LUT) pre-generated using an FDTD solver, where the LUT consisted of a set of mappings between nano-cylinder radius r to the modulation function: {rₙ→Cₙ, n=1, 2, . . . , N}. When given a target modulation function C(m, n), the LUT was searched for the nanocells that exhibit the phase delay closest to the specified target modulation function at each position (m, n) and used it as the nanocell shape at (m, n):

$$r ( m , n ) = {arg min}_{\{ {r}_{n} , n = 1 , … , N \}} \vert {∠C}_{n} - ∠C ( m , n ) \vert . \qquad ( 1 )$$

Random interleaving: A goal of the investigations was to generate a metasurface 56 that unevenly divides the wavefront energy to V focusing locations on the photosensor, allowing for V sub-images to form on the photosensor plane. For the experimental MetaHDR 50, the number of focusing locations V was selected as nine. As the number of spatial multiplexing is high and the energy division of each multiplexing is uneven, it was challenging to design the multifunctional metasurface 56 for the investigations by interleaving the shape profiles of multiple metasurfaces on a regular grid as reported in the prior art, which could cause high-order diffraction artifacts in the image. Instead, in the investigations leading to the present invention, a random interleaving design procedure was developed for the multifunctional metasurface 56 evaluated in the investigations.

The modulation functions Cᵢ(m, n), i=1, . . . , V of V focusing metasurfaces were generated via using Equation 2:

$${C}_{i} ( m , n ) = exp ( \frac{j 2 π}{λ} ( \sqrt{{( {mw}_{x} - {x}_{i} )}^{2} + {( {nw}_{y} - {y}_{i} )}^{2} + {Z}_{s}^{2}} - {Z}_{s} ) ) , \qquad ( 2 )$$

where (xᵢ, yᵢ, Zₛ) is the coordinate locations of a fronto-parallel incident plane wave selected to be focused on the photosensor plane, wₓ and w_{y} are the nanocell pitch, and λ is the designed wavelength of the wavefront. Then, the nano-cylinder radius of each nanocell 64, rᵢ(m, n), of the iₜₕ focusing metasurface 54 was determined by the nearest neighbor search from the pre-generated LUT via Eq. 1. Finally, the multifunctional metasurface 56 was designed via random interleaving the V focusing metasurfaces 54. The shape parameters of the multifunctional metasurface 56 were denoted as rₘ(m,n). The nano-cylinder radius of each nanocell 64 (m,n) were determined by randomly picking the nano-cylinder radius from one of the V focusing metasurface shape parameters rᵢ(m, n) at the same position according to a multinomial distribution:

$${r}_{m} ( m , n ) = {r}_{i} ( m , n ) , i ∼ Multinomial ( {p}_{1} , {p}_{2} , … , {p}_{V} ) = {\sum }_{i = 1}^{V} {p}_{i} = 1. \qquad ( 3 )$$

The probability of selecting from each focusing metasurface 54, p₁, p₂, . . . , p_{V}, determines the portion of the wavefront power that goes to each multiplexed image 60. This relationship and how to determine the probabilities, p₁, p₂, . . . , p_{V}, are discussed below.

Image formation model: A scene to be imaged is treated as a collection of incoherent point sources. For each point source located at X=[X, Y, Z], it emits a coherent wavefront that traverses through the optics. Using the ith focusing metasurface as the optics and assuming paraxial approximation, the image of the point source X is E(X)hᵢ(x−X/Z, y−Y/Z; Z), where E(X) denotes the irradiance level received by the photosensor from the point source X, and hᵢ(x, y, Z) represents the point spread function (PSF) of the focusing metasurface rᵢ(m, n) at object distance Z. The PSFs of the V focusing metasurfaces hᵢ(x, y, Z) are translational invariant with respect to the index i. Thus, the notation of the PSFs were simplified as:

hᵢ(x−xᵢ,y−yᵢ;Z)=h*(x,y;Z),i=1,2, . . . ,V, (4)

where h*(x, y; Z) is denoted the ideal PSF of the focusing metasurfaces. The PSF of the multifunctional metasurface 56 that was designed using random interleaving, denoted as hₘ(x, y; Z), is related to the ideal PSF h*(x, y; Z) via the following equation:

$${h}_{m} ( x , y ; Z ) \approx C \cdot ( {\sum }_{i = 1}^{V} {\underbrace{{p}_{i}^{2} h * ( x - {x}_{i} , y - {y}_{i} ; Z )}}_{signal} + {\underbrace{{β}_{i} ( x - {x}_{i} + y - {y}_{i} )}}_{residual} ) . \qquad ( 5 )$$

where the coefficient C is a normalization factor and the term βᵢ(x−xᵢ+y−yᵢ) is a background residual light centered at (xᵢ, yᵢ). Eq. 5 shows that the PSF of the multifunctional metasurface, hₘ(x, y, Z), consists of V multiplexes of the ideal PSFs. The signal term of each multiplex is a translation of the ideal PSF and has an approximate power ratio of Cp²ᵢ with respect to the ideal PSF.

When using the multifunctional metasurface 56 as the optics, we denote the irradiance distribution on the photosensor from the scene as Eₘ(x, y):

$$\begin{matrix}{E}_{m} ( x , y ) = {\sum }_{X} E ( X ) {h}_{m} ( x - X / Z , y - Y / Z ; Z ) , \\ ∝ {\sum }_{i = 1}^{V} {\underbrace{{p}_{i}^{2} E * ( x - {x}_{i} , y - {y}_{i} )}}_{signal} + {\underbrace{{b}_{i} ( x - {x}_{i} , y - {y}_{i} )}}_{residual} ,\end{matrix} \qquad ( 6 )$$

where E*(x, y) is the ideal irradiance distribution on the photosensor under the ideal PSF h*(x, y; Z). The residual terms in Eq. 5, βᵢ, become the background irradiance bi when summing over all points in the scene. By limiting the incident field of view of the optical system, the signal term of each multiplex is constrained to be separated from each other.

The full image measured by the entire photosensor, I(x, y, t), relates to the irradiance distribution according to the noise model of a digital camera:

I(x,y,t)=G·Poisson(η·t·Eₘ(x,y))+Gauss(0,σ²), (7)

where the coefficients G, η, and t represent gain, quantum efficiency, and exposure time, and σ² is the variance of the read noise of the photosensor. The full image panel was divided into V non-overlapping sub-images, labeled as Iᵢ(x,y). For simplicity, the variable t in the notation was skipped when unnecessary. Each sub-image Iᵢ(x,y) consisted of a multiplex of the ideal image. Its coordinate is centered at location (xᵢ, yᵢ) in the full image and has a uniform dimension across all sub-images.

Probability selection: It was desired to design the power ratio between the ith signal term and i+1ₜₕ signal term to be αᵢ|αᵢ+1. Therefore, according to Eq. 6, the random interleaving probability of each multiplex pᵢ is:

$${p}_{i} = \frac{\sqrt{{α}_{i}}}{{\sum }_{i = 1}^{V} \sqrt{{α}_{i}}} , i = 1 , 2 , … , V . \qquad ( 8 )$$

Gradient-based HDR Reconstruction: The HDR reconstruction formulation was created to tackle the imaging artifacts inherent to the MetaHDR system. According to Eqs. 6, 7, and 8, each sub-image Iᵢ(x, y) consists of both the signal and an inevitable background light:

Iᵢ(x,y)=G·Poisson(η·t·(αᵢE*(x,y)+Bᵢ(x,y)+Gauss(0,σ²). (9)

where the term Bᵢ is a generalized background irradiance that includes all background irradiances bᵢ in Eq. 6 that blends into the panel of sub-image Iᵢ(x, y):

$${B}_{i} ( x , y ) = {\sum }_{j = 1}^{V} {b}_{j} ( x - {x}_{j} + {x}_{i} , y - {x}_{j} + {x}_{i} ) . \qquad ( 10 )$$

Based on experimental observations, it was determined that it is safe to assume the generalized background irradiance Bᵢ(x, y) to be slowly varying with respect to the spatial coordinates (x, y) compared to the signal. Therefore, the gradient of the sub-images ∂Iᵢ/∂x and ∂Iᵢ/∂y only contains the gradient of the signal:

$$\frac{\partial {I}_{i}}{\partial x} ( x , y ) \approx G \cdot Poisson ( η \cdot t \cdot {α}_{i} {E}_{x}^{*} ( x , y ) ) + Gauss ( 0 , {σ}^{2} ) . \qquad ( 11 )$$

The equation is the same for ∂Iᵢ/∂_{y}. Then, the spatial gradient of the ideal irradiance distribution ∂E*/∂x and ∂E*/∂y was estimated based on the spatial gradient of the sub-images ∂Iᵢ/∂x and ∂Iᵢ/∂_{y} via the formulation:

$$\text{?} ( x , y ) = {arg max}_{{E}_{x}^{*} ( x , y )} Pr ( {E}_{x}^{*} ( x , y ) \vert \frac{\partial {I}_{1}}{\partial x} ( x , y ) , … , \frac{\partial {I}_{V}}{\partial x} ( x , y ) , {α}_{1} , … , {α}_{V} ) , \qquad ( 12 )$$

and the minimizer is

$$\text{?} ( x , y ) = \frac{{\sum }_{i = 1}^{V} {α}_{i} {M}_{i} ( x , y ) \frac{\partial {I}_{i}}{\partial x} ( x , y )}{G \cdot {\sum }_{i = 1}^{v} η \cdot t \cdot {α}_{i}^{2} \cdot {M}_{i} ( x , y )} . \qquad ( 13 )$$

The term Mᵢ(x, y) is a binary mask that filters out saturated pixels that could cause inaccurate gradient estimation:

$${M}_{i} ( x , y ) = \{ \begin{matrix}0 & if a pixel involved in calculating \frac{\partial {I}_{i}}{\partial x} ( x , y ) is saturated \\ 1 & otherwise\end{matrix} . \qquad ( 14 )$$

The process is the same for estimating E*_{y}. Eventually, the ideal irradiance distribution from the spatial gradient can be estimated via:

$$E * ( x , y ) = {F}^{- 1} ( - j \frac{{ω}_{x} F ( \text{?} ( x , y ) ) + {ω}_{y} F ( \hat{{E}_{y}^{*}} ( x , y ) )}{{ω}_{x}^{2} + {ω}_{y}^{2}} ) , \qquad ( 15 )$$

where F and F⁻¹ are Fourier and inverse Fourier transforms.

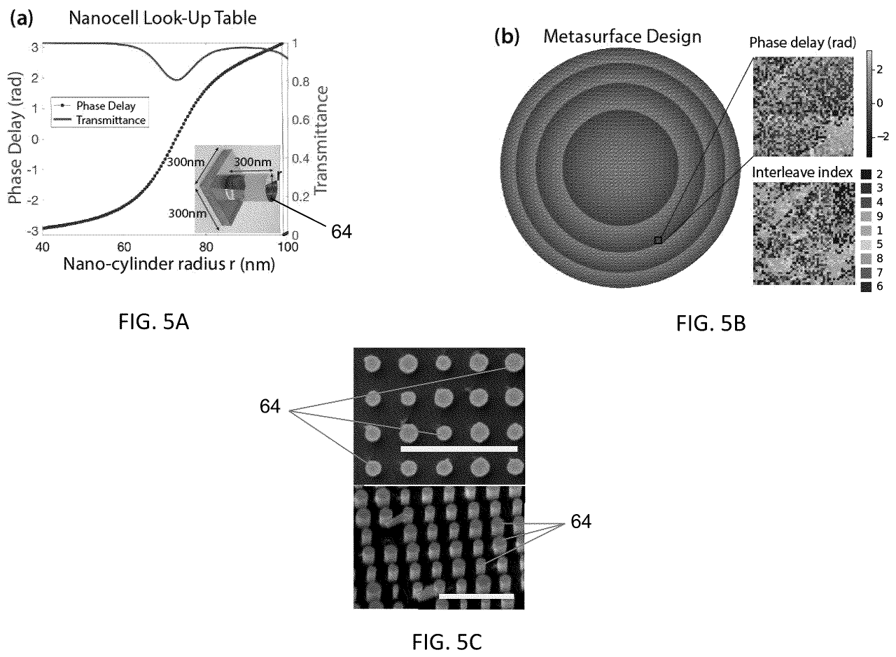

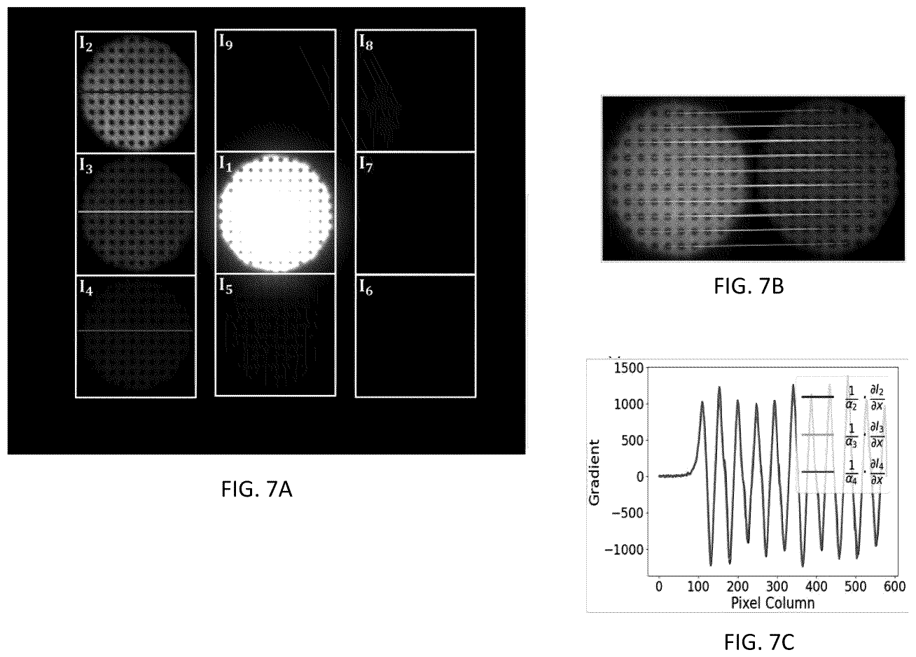

Experimental Results: For use in the experimental MetaHDR 50, a 1 mm diameter multifunctional metasurface 56 was designed and fabricated to divide (split) incident environmental light 58 into nine individual focused beams and deflect the focused beams onto a photosensor 62 to generate nine low-dynamic range (LDR) sub-images 60, i.e., V=9, in a 3×3 grid. The arrangement of the nine sub-images is shown in FIG. 7A. The power ratio between every two images 60 was two. The focal length of the metasurface 56 was 5 cm. The working wavelength was 650 nm. The nanocells 64 of the metasurface 56 had 300 nm×300 nm bases 66, and had α-silicon cylinders of 300 nm height to form nanopillars 68 centered on the bases. The nano-cylinder height was selected to make sure that the nanocells 64 can cover a 2π phase delay range. A Lumerical FDTD simulator was used to generate the LUT for phase delay and transmittance for the design process (FIG. 5A) and determined the metasurface shape profile following the random interleaving process described above. The phase delay profile and the random interleaving index profile of the experimental metasurface are displayed in FIG. 5B.

To verify the design, the point spread function (PSF) of the experimental metasurface was estimated by simulating a uniform intensity point source of wavelength 650 nm at a distance of 1 km, sending a spherical wave towards the metasurface. The metasurface was simulated using a differentiable flat-optics framework known as “D-flat.” The metasurface was designed to have nine focal points, each with a distinct brightness level. In addition to verifying the PSF arrangements, the average peak signal-to-noise ratio (PSNR) of synthesized images was also examined using the PSFs under the noise model in Eq. 7 for various realistic photon levels and noise levels. The PSNR of a simulated image was obtained with the designed PSF at various noise levels. The simulated images were generated as the convolution of the simulated PSF and a 512×512 8-bit image. The PSNR values remained stable across the photon levels and noise levels, which suggested the sufficient quality of the formed sub-images.

The fabrication procedure of the metasurface started from a bare fused silica glass coated with a 300 nm thick α-silicon film through plasma-enhanced chemical vapor deposition, Oxford Plasma Pro 100. The silica wafer was then spin coated with a 200 nm thick ARP6200 resist. Next, to help mitigate charging effects and height sensor error during the electron beam lithography process, a 20 nm thick aluminum (Al) layer was deposited onto the sample. Using the electron-beam lithography, EBPG 5150, the sample was patterned with an electron dose of 700 uC/cm². Afterwards, the sample was soaked in Al etchant type A to remove the Al layer followed by a 90-second development in AR600-546. A 30-nm-thick Al₂O₃ layer was deposited on the sample, followed by lift-off to prepare an etching hard mask. Finally, plasma dry etching was performed using SF₆ and C₄F₈ chemistries. FIG. 5C shows the scanning electron microscope (SEM) photos of nano-structures of the fabricated metasurface.

The aforementioned experimental MetaHDR 50 represented in FIG. 6A was assembled using the fabricated metasurface. As visualized in FIG. 6A, the experimental MetaHDR 50 can be reconfigured as a microscope using an optional 75 mm focal length objective lens 76. The photosensor 62 of the experimental MetaHDR was a conventional monochrome CMOS camera able to capture full images of 2448×2048 pixel resolution.

Calibration: The calibration of the experimental MetaHDR involved geometric alignment and contrast registration. The geometric alignment determined a homography Hᵢⱼ between every pair of sub-images Iᵢ(x, y) and Iⱼ(x, y). All sub-images were aligned to a reference sub-image through perspective warping using the calibrated homographies. FIG. 7B shows the homography estimation process, where a calibration target was imaged using the MetaHDR and detected corresponding key points between sub-images to calculate the homography.

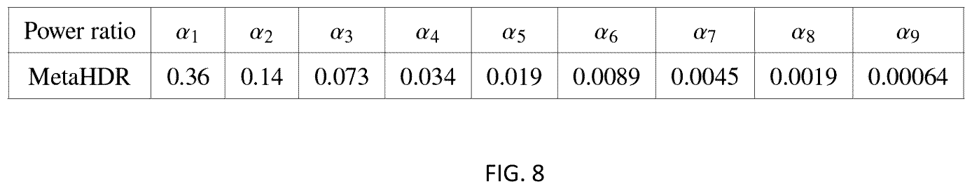

The contrast registration estimates the power ratio of the signal term of each sub-image, αᵢ, in Eq. 9. The MetaHDR was used to capture the V sub-images 60 of a static, textured pattern 78 (e.g., a scene). For each sub-image, Iᵢ(x, y), an exposure time tᵢ was selected so that the specific sub-image was unsaturated and properly exposed. The unnormalized power ratio \tilde{α}ᵢ of the ith sub-image was estimated by registering its spatial gradient with that of a reference sub-image:

$${\tilde{α}}_{i} = \frac{{t}_{2}}{{t}_{i}} \cdot \frac{{\sum }_{x , y} {‖ ∇ {I}_{i} ( x , y ) ‖}^{2}}{{\sum }_{x , y} ∇ {I}_{i} ( x , y ) \cdot ∇ {I}_{2} ( x , y )} , \qquad ( 16 )$$

where ∇Iᵢ=[∂Iᵢ/∂ₓ, ∂Iᵢ/∂_{y}]^{T}. In the investigations, I₂(x, y) was used as the reference sub-image. The normalized power ratio αᵢ was then calculated so that it reflects the power ratio of each sub-image with respect to the ideal image. FIG. 8 lists the estimated normalized power ratios di of the experimental MetaHDR 50. The power ratio of adjacent images was approximately two, which was consistent with the intended design. The power ratio between the brightest and dimmest images was α₁/α₉=562.5, which meant that the system could achieve 562.5 times or 55.00 dB extra dynamic range than that of the photosensor. To examine the quality of the contrast registration, the cross-section of contrast-registered sub-image spatial gradient (1/αᵢ)·∂Iᵢ/∂ₓ was also visualized in FIG. 7C. Qualitatively, the spatial gradient of each sub-image was shown to be accurately aligned after their corresponding power ratios were canceled.

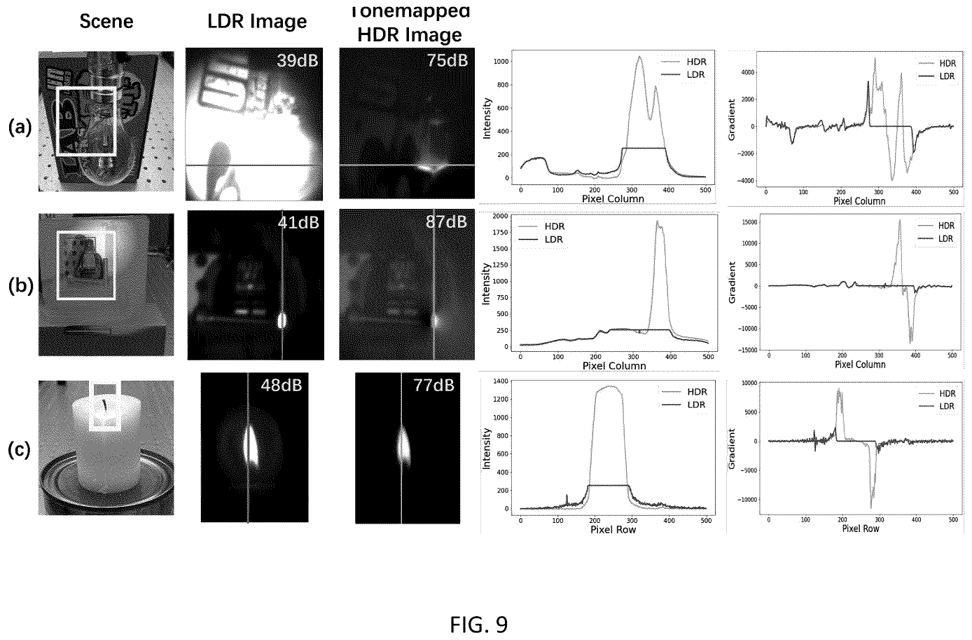

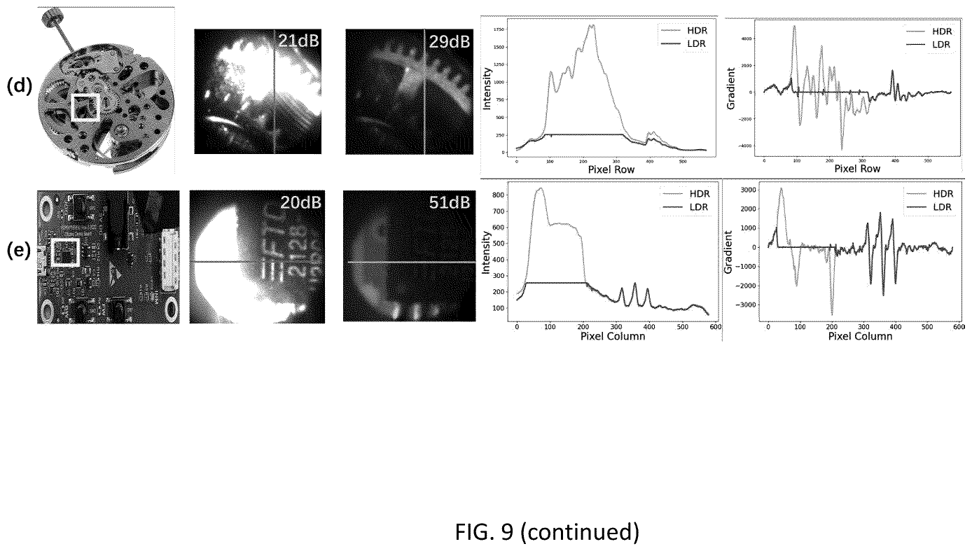

HDR Imaging Results: Without the objective lens 76, the experimental MetaHDR camera 70 can capture sharp images of 10 cm×10 cm dimension objects at 2 m away. With the objective lens 76, the experimental MetaHDR camera 70 can image 2.5 mm×2.5 mm objects placed at around 3 cm away from the diaphragm 72. The reconstructed HDR image is of 570×570 pixel resolution with and 500×500 without the objective lens. FIG. 9 shows sample HDR images taken using the experimental MetaHDR camera 70 without the objective lens 76 (FIG. 9 rows (a)-(c)) and with the objective lens 76 (FIG. 9 rows (d)-(e)). Rows (a)-(e) represent five different scenes targeted to capture the images. The column labeled “Scene” contains photos of the imaged scenes with a bounding box indicating the area captured by the MetaHDR. The column labeled “LDR Image” contains the brightest LDR sub-image captured for each scene. The numbers in the top right corners of the LDR sub-images indicate the dynamic ranges of the sub-images. The column labeled “Tonemapped HDR Image” contains tonemapped HDR images reconstructed using a gradient-based fusion method, with the dynamic range of each image indicated in its top right corner. All dynamic range values were calculated as the maximum pixel value divided by the minimum pixel value in the field of view. The last two columns in FIG. 9 are cross-sections of the intensity and spatial gradients of the LDR sub-images and reconstructed HDR images, which clearly show the saturation of the LDR sub-images. With the objective lens, the experimental MetaHDR functions as a microscope with a 2.5 mm×2.5 mm field of view and a resolution of around 20 μm.

The MetaHDR camera 70 was able to simultaneously record the radiance profile of an extremely bright incandescent light bulb and see the dark textured plane in the scene (FIG. 9 row (a)), and also record HDR images of dynamic scenes such as a flame (FIG. 9 row (c)).

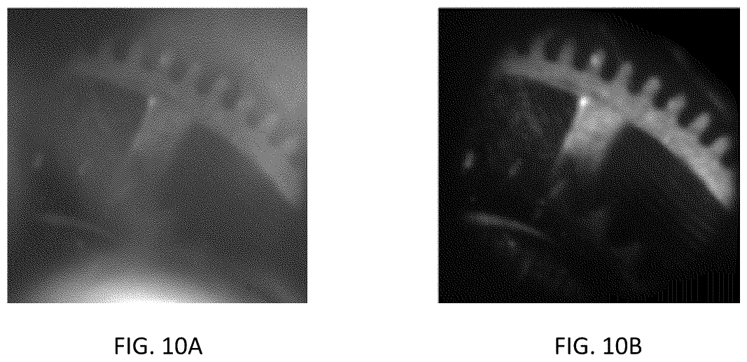

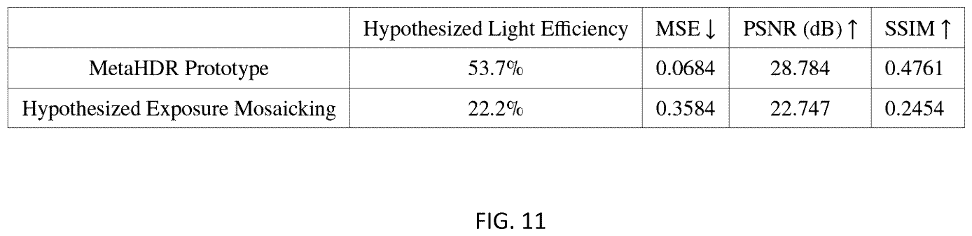

FIGS. 10A and 10B provide a qualitative comparison of the HDR image reconstructed using the gradient-based fusion method according to aspects of the present invention versus a previously known intensity-based HDR fusion method reported in Debevec et al., “Recovering high dynamic range radiance maps from photographs,” SIGGRAPH 97 (1997). The gradient approach seen in FIG. 10B clearly attenuated various artifacts, including the background light and the blending of neighboring sub-images. Thus, the gradient-based method of the present invention effectively removed the optical artifacts caused by residual lights.

Besides HDR still images, the MetaHDR system 50 can also capture HDR video images in real-time, as was demonstrated with two HDR videos of moving objects captured using the test camera 70 both with and without the objective lens 76.

Light efficiency comparison: The MetaHDR system 50 is complementary to existing HDR solutions that use pixel mosaicking to achieve single-shot exposure bracketing, including using mosaicked optical filter arrays and/or mosaicked shutter times. These exposure mosaicking methods can operate in a broader wavelength than MetaHDR. Meanwhile, for applications that only require a single wavelength, the MetaHDR system 50 can achieve a higher light efficiency than exposure mosaicking, as the latter solution discards a portion of incident light by the filter arrays or the reduced shutter times during a single capture. FIG. 2 contains a table of the estimated light efficiency of the experimental MetaHDR and an ideal nine-exposure mosaicking imager. The HDR quality of both solutions were also assessed under the estimated light efficiency. In this comparison, the MetaHDR system demonstrated two times higher light efficiency than exposure mosaicking, and 6 dB higher PSNR in HDR reconstruction according to the estimated light efficiency.

HDR Sensing Results: The MetaHDR's single-shot HDR capability to improve traditional computer vision solutions was also explored. Specifically, the MetaHDR was utilized to capture the full intensity profile of specularities on reflective materials in a single shot and use it to estimate the material properties, including surface reflectance or local curvature.

Single-shot surface reflectance calibration: The ability of the MetaHDR to calibrate the surface reflectance of glossy materials, such as metals, in a single shot, was explored. Traditionally, this task has only been demonstrated using multi-shots exposure bracketing to capture the full intensity profile of the specularities. A precision ball with a known radius r was placed in front of the MetaHDR camera 70. Using a background light to locate the contour of the precision ball, the 3D position X and surface normal N of the point on the ball that corresponds to every pixel (x, y) in the captured image was estimated. Then, a directional light was fixed onto the ball, which created a specularity on the surface After reconstructing the HDR irradiance map of the scene E*(x, y), the lighting direction L was estimated via L=2N₀−V, where vector No is the surface normal of the point that corresponds to the brightest pixel in the irradiance map and vector Vis the viewing direction. The orthographic projection was assumed and set V=[0, 0, 1]^{T}. Finally, using the HDR irradiance map, the surface reflectance model was fit through the following optimization:

$$\hat{k} = arg {min}_{k} {\sum }_{x , y} {( E * ( x , y ) - ρ L ( L , V , N ( x , y ) ; k ) )}^{2} , \qquad ( 17 )$$

where the coefficient ρ is the normalization parameter and L(L,V,N; k)) is the parameterized surface reflectance model with parameters k. The Phong reflectance model was adopted, which has been broadly used for modeling the reflectance of glossy materials:

L(L,V,N;k={N,Kₛ,K_{d},Kₐ})=Kₛ·(max(V·R,0))^{N}+K_{d}·(max(N·R,0)+Kₐ. (18)

The coefficient N describes the reflectivity of the material, and coefficients Kₛ, K_{d}, and Kₐ are the weights of specular, diffuse, and ambient components of the reflection. The investigations showed that by using a precision ball as the target, the 3D position and surface normal direction of every pixel from the circular contour of the ball could be determined.

The MetaHDR was used to calibrate the surface reflectance of multiple glossy materials, including stainless steel, tungsten carbide, and brass. To verify the accuracy of the reflectance calibration, the image of the precision ball was rendered from a novel lighting direction and compared to the real measurements. The cross-section of the rendered image and the real measurement closely matched each other. A rendered image of the calibrated material under custom environments showed that the specular reflectance, which consists of the most power, is approximately uniform across the visible spectral band.

Single-shot surface curvature estimation: The investigations demonstrated using the MetaHDR system to simultaneously estimate the lighting direction and the surface curvature of the material from the specularity of a reflective object, given its surface reflectance model. A surface reflectance model was used measured in advance from a 2 mm stainless steel precision ball to recover the local curvature of unknown surfaces of the same material at the specularities and the lighting direction. The unknown surfaces were precision balls with diameters of 1 mm and 2.5 mm to provide access to the ground truth surface shape and lighting direction. The reconstruction was based on the intensity profile of the specularity within each local patch and a weak prior knowledge that the surface is convex for initialization of coefficients a. The reconstructed surfaces were plotted and overlaid with ground truths. The estimated lighting direction bL, the estimated surface normal of the brightest pixel cN0, and the ground truth lighting direction L were also visualized. The average error of the estimated lighting direction bL was 9.5°. Traditionally, estimating the shape of reflective materials has been a challenging task in computer vision, which involves using rigorously calibrated diffuse illumination to avoid specularities and perform photometric stereo or shape from shading, or only using the unsaturated pixels in the low dynamic range images of the object. Using the MetaHDR system, the local curvature of the object at the specularity can be directly measured in a single shot without knowledge of the light source and with a weak prior of the shape.

In the investigations, the distance map of the local surface at the specularity was assumed to follow the quadratic function:

Z(x,y;a)=a₁(x−x₀)²+a₂(y−y₀)+a₃(x−x₀)(y−y₀)+α₄(x−x₀)+α₅(y−y₀), (19)

where Z is the distance of the point corresponding to pixel (x, y), the vector a=[a₁, . . . , a₅]^{T} is the parameterization of the shape, with [a₁, . . . , a₃] indicating the curvature, and (x₀, y₀) are the pixels with the highest intensity in the specularity. The shape of the local surface at the specularity and the lighting direction L can be estimated via the following optimization problem:

$$\hat{a} , \hat{L} = arg {min}_{a , L} {\sum }_{x , y} {( E * ( x , y ) - ρ L ( L , V , N ( x , y ; a ) ; k ) )}^{2} . \qquad ( 20 )$$

where the vector V is the viewing direction and N is the surface normal direction. To avoid ambiguities in the solution, the second-order coefficients a₁, . . . , a₃ was initialized as negative values based on the prior knowledge that the shape of the local surface is convex. The investigations showed that the MetaHDR system 50 successfully predicted the 3D shape of the two stainless steel surfaces at the specularity and the lighting direction in a single shot with a small error.

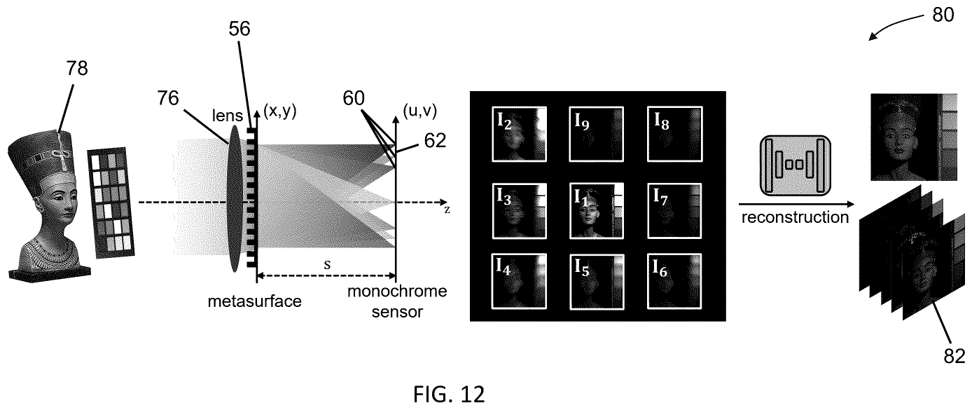

FIG. 12 illustrates another nonlimiting example of a metasurface camera and imaging system 80 (also referred to as a “MetaH2” or “MetaH2 system”) that incorporates a multifunction metasurface 56 and is configured to jointly perform high dynamic range (HDR) imaging and hyperspectral imaging in a single snapshot. The MetaH2 system 80 uses an optical system including a lens 76 and a custom-engineered metasurface 56 that splits and focuses incoming light onto multiple focal regions 60 of a monochrome photosensor 62. Each focal spot 60 has a distinct energy and dispersion. Consequently, the MetaH2 system 80 can capture multiple sub-images I1-I9 of the scene, each with different dynamic ranges and chromatic aberrations, in a single shot. As can be readily seen, the optics portion of the MetaH2 system 80 is generally similar to the MetaHDR system 50 and the camera system 70, and reference is made thereto for further description. The image formation process jointly achieves exposure bracketing and computed tomography imaging spectrometry (CTIS), resulting in the simultaneous formation of images with different exposure values and chromatic fringing. The sub-images 60 can then be processed by a reconstruction algorithm to generate both a high-dynamic-range (HDR) image and a hyperspectral datacube 82 simultaneously. In some example configurations, these measurements are processed by a deep neural network architecture to reconstruct an HDR image and the hyperspectral datacube jointly. In contrast to previously known methods that require narrow bandpass filters to limit incident light to a single wavelength, the MetaH2 system 80 uses the inherent chromaticity of the metasurface 56 as an optical encoder for the hyperspectral information, which broadens the operational bandwidth, significantly improving the light efficiency compared to previous metasurface imagers.

The MetaH2 system 80 includes an achromatic refractive lens 76 paired with a polarization-insensitive V-beam splitting metasurface 56 as the optical assembly. The refractive lens 76 focuses the incident beam onto the plane of the sensor 62 while the metasurface 56 splits and deflects the light onto a plurality V of off-axis positions. The V-beam splitting metasurface 56 can be viewed as the interleaving of V deflective metasurfaces. Simulation and real-world experiments showed that the dispersion of the metasurface 56 induces a chromatic shift in the deflected PSF while also producing residual light focused by the refractive lens without any deflection. The full image contains V spatially multiplexed sub-images 60, as shown in FIG. 12. While the number V of sub-images in the present description and investigations was set at 9, it is understood more or fewer sub-images may be formed depending on the design of the metasurface 56. Preferably, at least four or more sub-images 60 are provide to provide robust data accumulation. For the purpose of post-processing, each sub-image is cropped centered at the designed location (ui, vi) from the full image, which is denoted as Ii(u, v).

Various post-processing algorithms can be used to reconstruct H2 after the image formation process. For instance, the present nonlimiting example follows a reconstruction procedure outlined in a recent work that utilizes the deep network architecture that is a variant of the Deep Wiener Deconvolution Network (DWDN). The algorithm first hallucinates a feature cube Li∈RH×W×Λ from each measurement Ii∈RH×W×1, where H×W is the dimension of the image and A is the dimension of the hyperspectral distribution. It then performs a Wiener deconvolution on all feature cubes:

$$\tilde{f} ( x , y , λ ) = {ℱ}^{- 1} \{ \frac{{\sum }_{i = 1}^{9} \overline{ℱ ( {h}_{i} )} ℱ ( {ℐ}_{i} )}{{\sum }_{i = 1}^{9} \overline{ℱ ( {h}_{i} )} ℱ ( {h}_{i} )} \} . \qquad ( 12 )$$

where F and F−1 are Fourier and inverse Fourier transforms in the spatial dimension. The deconvolved features ^{~}f(x, y, λ) are further refined through a U-Net to produce the final hyperspectral datacube \hat{ }f(x, y, λ), each 2D slice being an HDR image. Although other hyperspectral reconstruction algorithms may be used for the MetaH2 system 80, it is believed that this reconstruction algorithm demonstrates the top reconstruction accuracy.

A nonlimiting example working prototype of the MetaH2 system 80 was built based on the design of the camera system 70. The prototype MetaH2 system 80 had of a 1-mm diameter metasurface 56 that divides the light into nine regularly spaced positions 60 on the photosensor 62. Besides beam splitting, the metasurface 56 has a 20 dpt optical power or 5 cm focal length. Due to the small numerical aperture of the system, the metasurface 56 is approximately equivalent to the achromatic lens 76 and the beam splitting metasurface in the MetaH2 optical design. The system has an objective lens 76 to image close objects. Significant residual light could be observed in the central sub-image when the incident wavelength is shorter than 600 nm, possibly due to a fabrication defect of the metasurface. Therefore, a bandpass filter is inserted to set the working bandwidth of the system to [600 nm, 700 nm]. Nonetheless, the bandwidth of the MetaH2 system 80 is still much broader than many previously known metasurface imaging systems, which typically have a 10 nm bandwidth. The model is subsequently retrained by synthetic images generated with real-captured PSFs and hyperspectral datasets with a numerically enhanced dynamic range. In investigations, the prototype demonstrates measuring 60 dB dynamic range and a 10 nm spectral resolution using a monochrome photosensor. Investigations showed that the MetaH2 system 80 consistently outperformed pervious snapshot hyperspectral imaging modalities in visual comparisons and forms the most sub-images in a snapshot, leading to the highest hyperspectral reconstruction accuracy across all four postprocessing algorithms tested. Sample results also showed that the camera system 80 captures HDR and hyperspectral data in a single snapshot, enabling measurement of dynamic objects (e.g., a moving gear) and highly reflective surfaces (e.g., circuit electronics).

Processing of the raw image data of the multiple low dynamic range images obtained by any one or more of the systems 50, 70, and/or 80 described herein, for example, may be implemented by one or more digital processors, such as computer processors and any appropriate attendant hardware and/or software, executing software and/or hardware instructions configured to implement any one or more of the algorithms disclosed herein.

From the foregoing, it can be seen that the MetaH2 metasurface-based camera 80 provides for both joint hyperspectral imaging and HDR imaging. The metasurface 56 encodes both types of information into spatially multiplexed measurements, each characterized by distinct chromatic aberration and power level. Quantitative studies show that the MetaH2 system 80 achieves consistently higher hyperspectral imaging accuracy compared to previously known snapshot techniques at the cost of reduced FOV.

Discussion: The MetaHDR system 50 disclosed herein integrates nanophotonics and computer vision to advance digital imaging and visual sensing. In the investigations leading to the present invention, this integration was demonstrated to produce a new HDR solution that increases the dynamic range compared to previous methods and demonstrated single-shot imaging and visual sensing. With this capability, the MetaHDR system 50 has broad applications in surveillance and security, microscopic imaging, advanced manufacturing, as well as other fields and applications. Modifications to the multifunctional metasurface are believed to be capable of compensating for relatively small deflection angles of off-axis sub-images and small numerical apertures of the metasurface.

In view of the foregoing, it is believed that the benefits of the MetaHDR system 50 may include at least one or more of the following, although other benefits and aspects may also be provided:

A single-shot HDR imaging and sensing system with a multifunctional metasurface designed using a random interleaving approach;

A gradient-based HDR reconstruction algorithm paired with the hardware that effectively attenuates various optical artifacts caused by the multifunctional metasurface; and

An experimental MetaHDR camera that can, in some configurations, achieve single-shot HDR still imaging and videography with more than 50 dB extra dynamic range compared to the original photosensor, and/or single-shot surface reflectance and curvature estimation from specularities of reflective materials.

It is also believed that the benefits of the MetaH2 system 80 may include at least one or more of the following, although other benefits and aspects may also be provided:
a metasurface imaging modality for simultaneous exposure bracketing and CTIS; and
a metasurface camera and imaging system (MetaH2) that performs joint HDR and hyperspectral imaging.

As previously noted above, though the foregoing detailed description describes certain aspects of one or more particular embodiments of the invention and investigations associated with the invention, alternatives could be adopted by one skilled in the art. For example, the MetaHDR system and its components could differ in appearance and construction from the embodiment described herein and shown in the drawings, functions of certain components of the MetaHDR system could be performed by components of different construction but capable of a similar (though not necessarily equivalent) function, various parameters could be modified, and appropriate materials could be substituted for those noted. As such, and again as was previously noted, it should be understood that the invention is not necessarily limited to any particular embodiment described herein or illustrated in the drawings.

1. A high-dynamic range imaging and sensing system comprising:
a photosensor; and
a multifunctional metasurface comprising randomly interleaved nanocells that unevenly divide incident light into focused beams of different powers and deflect the focused beams onto different locations on the photosensor to form multiple low dynamic range images.

2. The high-dynamic range imaging and sensing system of claim 1, wherein the nanocells have bases and nanopillars on the bases.

3. The high-dynamic range imaging and sensing system of claim 2, wherein the bases have a fixed size and the nanopillars have a fixed height.

4. The high-dynamic range imaging and sensing system of claim 2, wherein the nanopillars have randomly differing radii.

5. The high-dynamic range imaging and sensing system of claim 1, wherein the different locations on the photosensor are disposed at evenly spaced positions on the photosensor.

6. The high-dynamic range imaging and sensing system of claim 1, wherein each of the focused beams contains a preselected ratio of power incident on the multifunctional metasurface.

7. The high-dynamic range imaging and sensing system of claim 1, wherein the photosensor comprises a CMOS camera.

8. The high-dynamic range imaging and sensing system of claim 1, wherein the photosensor comprises a monochrome photosensor.

9. The high-dynamic range imaging and sensing system of claim 1, further comprising a processor configured to execute a gradient-based HDR reconstruction algorithm of the multiple low dynamic range images for attenuating one or more optical artifacts caused by the multifunctional metasurface.

10. The high-dynamic range imaging and sensing system of claim 1, further comprising a processor configured to execute a reconstruction procedure that utilizes the deep network architecture on the multiple low dynamic range images to jointly perform high dynamic range (HDR) imaging and hyperspectral imaging in a single snapshot.

11. A high-dynamic range camera comprising:
the high-dynamic range imaging and sensing system of claim 1; and
a diaphragm configured to direct the incident light onto the multifunctional metasurface.

12. The high-dynamic range camera of claim 11, further comprising an objective lens operatively disposed between the diaphragm and the multifunctional metasurface.

13. A method of operating the high-dynamic range imaging and sensing system of claim 1, the method comprising:
performing high-dynamic range imaging and sensing in a single-shot exposure to construct a high-dynamic range image.

14. The method of operating the high-dynamic range imaging and sensing system of claim 13, further comprising:
jointly processing the multiple low dynamic range images using a gradient-based high-dynamic range fusion algorithm to reconstruct a high-dynamic range image.

15. The method of operating the high-dynamic range imaging and sensing system of claim 13, further comprising:
jointly perform high dynamic range imaging and hyperspectral imaging in a single snapshot.

16. The method of claim 13, wherein the multiple low dynamic range images comprise more than four low dynamic range images.

17. The method of claim 13, wherein the multiple low dynamic range images comprise at least nine low dynamic range images.

18. The method of claim 13, the method further comprising attenuating residual light artifacts caused by the multifunctional metasurface.

19. The method of claim 13, wherein the high-dynamic range image is a still image.

20. The method of claim 8, wherein the high-dynamic range image is a video image.
